(19) United States
(12) Patent Application Publication
(10) Pub. No.: US 2025/0355996 A1
(43) Pub. Date: Nov. 20, 2025

(54) CLOUD SECURITY SOURCE POOL SYSTEM BASED ON DISTRIBUTED ARCHITECTURE

(71) Applicant: Huaneng Information Technology Co., Ltd., Qingdao (CN)

(72) Inventors: Lei Cui, Qingdao (CN); Shuo Han, Qingdao (CN); Sheng Ye, Qingdao (CN); Hao Guo, Qingdao (CN); Qifeng Wu, Qingdao (CN); Lei Chen, Qingdao (CN); Faxing Chen, Qingdao (CN); Fuhai Gao, Qingdao (CN); Yan Li, Qingdao (CN); Yuxiang Lu, Qingdao (CN)

(73) Assignee: Huaneng Information Technology Co., Ltd., Qingdao (CN)

(21) Appl. No.: 19/281,519

(22) Filed: Jul. 25, 2025

(30) Foreign Application Priority Data
Jun. 17, 2025 (CN) 202510811836.8

(51) Int. Cl. G06F 21/53; G06F 21/55

(52) U.S. Cl. CPC G06F 21/53; G06F 21/552

(57) ABSTRACT

The disclosure relates to the technical field of cloud resource pools, and in particular to a cloud security source pool system based on distributed architecture. The system includes: a central control unit, configured for building a cloud resource pool according to security device parameters, where the cloud resource pool includes multiple virtual security machines; and a security monitoring unit, configured for setting multiple request categories according to network structure parameters. The security monitoring unit is further configured for constructing a security sub-model of each of the request categories. Based on the distributed architecture and virtualization technology, each security device is built as a virtual security machine, and a cloud resource pool is built according to all virtual security machines, so as to realize the dynamic call of all security resources, and at the same time, multiple request categories are built based on historical parameters.

### CROSS-REFERENCE TO RELATED APPLICATIONS

This application claims priority of Chinese Patent Application No. 202510811836.8, filed on Jun. 17, 2025, the content of which is hereby incorporated by reference.

### TECHNICAL FIELD

The disclosure relates to the technical field of cloud resource pools, and in particular to a cloud security source pool system based on distributed architecture.

### BACKGROUND

With the rapid development of cloud computing technology, enterprise business systems are gradually migrating to cloud and distributed architecture, and the traditional security protection model based on physical boundaries is facing severe challenges. Existing security solutions mainly have the following defects.

Security capabilities are usually deployed in the form of independent hardware or virtual devices, which makes it difficult to achieve unified scheduling and flexible expansion of resources, resulting in low resource utilization and high operation and maintenance costs. In the scenario of sudden business traffic, the traditional centralized security architecture may not dynamically expand and contract capacity, which is easy to form a performance bottleneck, and it is difficult to meet the fine-grained security requirements of distributed architectures such as microservices and containers.

### SUMMARY

The purpose of the disclosure is to solve the above technical problems, and the disclosure provides a cloud security source pool system based on distributed architecture, aiming at improving the security protection capability and protection efficiency of the system.

In some embodiments of the disclosure, based on the distributed architecture and virtualization technology, each security device is built as a virtual security machine, and a cloud resource pool is built according to all virtual security machines, so as to realize the dynamic call of all security resources, and at the same time, multiple request categories are built based on historical parameters, and corresponding security sub-models are constructed according to the characteristic parameters of different request categories, so as to realize the security monitoring efficiency of various data.

In some embodiments of the disclosure, the resource proportion of each security sub-model is dynamically adjusted based on the expected request parameters of a single monitoring period, and at the same time, the resource call parameters of each security sub-model are dynamically corrected by building time sequences, thus improving the overall operating efficiency and security protection capability of the system.

In some embodiments of the disclosure, a cloud security source pool system based on a distributed architecture is provided, including:
a central control unit, configured for building a cloud resource pool according to security device parameters, where the cloud resource pool includes multiple virtual security machines; and
a security monitoring unit, configured for setting multiple request categories according to network structure parameters;
where the security monitoring unit is further configured for constructing a security sub-model of each of the request categories;
where the central control unit includes:
a first processing module, configured for building a virtual security machine sequence A, and A=(a₁, a₂ . . . aᵢ . . . aₙ), where aᵢ is an i-th virtual security machine; n is a number of the virtual security machines;
a second processing module, configured for constructing the security sub-model of each of the request categories and setting resource call parameters of each of security sub-models; and
a third processing module, configured for obtaining a feedback data packet of each of security sub-models according to a preset feedback time node, and determining whether to generate a correction instruction according to all feedback data packets.

In some embodiments of the disclosure, the security monitoring unit includes:
a first monitoring module, configured for building a request category sequence P, and P=(p₁, p₂ . . . pᵢ . . . . Pₘ), where pᵢ is an i-th request category; m is a number of the request categories; and
a second monitoring module, configured for constructing the security sub-model of each of the request categories;
where the second monitoring module is further configured for obtaining real-time user request and setting scheduling parameters of the security sub-model according to the real-time user request.

In some embodiments of the disclosure, constructing the security sub-model of each of the request categories includes:
sequentially setting pi as a target request category according to the request category sequence P;
generating a historical data packet of the target request category;
generating an association evaluation value between the target request category and each of the virtual security machines according to a request data packet;
building an associated evaluation value sequence B of the target request category, and B=(b₁, b₂ . . . bᵢ . . . bₙ), where bᵢ is an associated evaluation value of the target request category and the i-th virtual security machine; n is a number of the virtual security machines;
presetting an associated evaluation value threshold B1;
if bᵢ>B1, setting the i-th virtual security machine as an associated virtual machine of the target request category;
generating a call channel of the target request category and each of the associated virtual machines, and generating a call substructure of the target request category according to all call channels;
generating the security sub-model of the target request category according to the call substructure;
sequentially generating the security sub-model of each of the request categories; and
building a security sub-model sequence W, and W=(w₁, w₂ . . . . wᵢ . . . . wₘ), where wᵢ is a data sub-model of the i-th request category; m is a number of the request categories.

In some embodiments of the disclosure, generating the target request category and the associated evaluation value of each of the virtual security machines includes:
sequentially setting aᵢ as a target virtual security machine according to an virtual security machine sequence A; and
generating an associated evaluation value b between the target virtual security machine and the target request category according to the historical data packet;

$$b = [ {\sum }_{i = 1}^{{θ}_{1}} {η}_{i} * {s}_{i} ] ;$$

where, θ1 is a number of associated evaluation indexes; ηᵢ is an influence factor of an i-th associated evaluation index; sᵢ is a reference value of the i-th associated evaluation index generated based on the historical data packet.

In some embodiments of the disclosure, setting resource call parameters of each of security sub-models includes:
presetting multiple monitoring periods;
generating expected request parameters of a current monitoring period according to a preset request prediction model;
generating an expected load value of each of the security sub-models in the current monitoring period according to the expected request parameters;
setting a first-level resource call strategy according to all expected load values;
generating an expected fluctuation value of the current monitoring period, and setting multiple time intervals in the current monitoring period according to the expected fluctuation value;
building a time interval sequence T, and T=(t₁, t₂, . . . tᵢ, . . . tᵣ), where tᵢ is an i-th time interval; r is a number of the time intervals; and
generating a deviation evaluation value in each of the time intervals, and determining whether a compensation sub-strategy is generated in each of the time intervals according to the deviation evaluation value.

In some embodiments of the disclosure, generating an expected load value of each of security sub-models in the current monitoring period includes:
sequentially setting wᵢ as a target sub-model according to the security sub-model sequence W;
generating an expected load value c of the target sub-model according to the expected request parameters of the current monitoring period;

$$c = [ {\sum }_{i = 1}^{{θ}_{2}} {β}_{i} * {v}_{i} ] ;$$

where, θ2 is a number of load evaluation indexes; βᵢ is an influence factor of an i-th load evaluation index; vᵢ is a first-level reference value of the i-th load evaluation index in the target sub-model generated based on the expected request parameters;
sequentially generating an expected load value of each of the security sub-models in the current monitoring period; and
building an expected load value sequence C of the current monitoring period, and C=(c₁, C₂ . . . . Cᵢ . . . . Cₘ), where cᵢ is an expected load value of an i-th security sub-model in the current monitoring period.

In some embodiments of the disclosure, setting multiple time intervals in the current monitoring period includes:
generating the expected fluctuation value d of the current monitoring period;

$$d = e 1 * Q 1 * [ {\sum }_{i = 1}^{m} {j}_{i} ] + e 2 * Q 2 * [ {\sum }_{i = 1}^{m} {( {j}_{i} - j ′ )}^{2} ] ;$$

where e1 is a preset first weight coefficient; e2 is a preset second weight coefficient; Q1 is a preset first fixed coefficient; Q2 is a preset second fixed coefficient; jᵢ is a sub-fluctuation value of the i-th security sub-model in the current monitoring period; j′ is an evaluation value of all sub-fluctuation values; and
setting a duration of a single time interval according to the expected fluctuation value d.

In some embodiments of the disclosure, determining whether a compensation sub-strategy is generated in each of the time intervals includes:
sequentially setting tᵢ as a target time interval according to the time interval sequence T;
generating a request sub-data packet of the target time interval according to the expected request parameters of the current monitoring period;
sequentially setting wᵢ as a sub-model to be evaluated according to the security sub-model sequence W;
generating a load deviation value d of the sub-model to be evaluated in the target time interval according to the request sub-data packet;

$$d = [ {\sum }_{i = 1}^{{θ}_{2}} {β}_{i} * {( {v}_{1 i} - {v}_{2 i} )}^{2} ] ;$$

where, θ2 is a number of the load evaluation indexes; βᵢ is an influence factor of the i-th load evaluation index; v₁ᵢ is a first-level reference value of an i-th load evaluation index in the sub-model to be evaluated generated based on the expected request parameters; v₂ᵢ is a second-level reference value of the sub-model to be evaluated generated based on the request sub-data packet in the target time interval;
sequentially generating a load deviation value of each of the security sub-models in the target time interval;
generating a deviation evaluation value f of the target time interval according to all load deviation values;

$$f = {\sum }_{i = 1}^{m} {d}_{i} ;$$

where, dᵢ is a load evaluation value of an i-th security sub-model in the target time interval;
presetting a deviation evaluation value threshold F1;
if f>F1, generating the compensation sub-strategy of the target time interval; and
sequentially determining whether each of the time intervals generates the compensation sub-strategy.

In some embodiments of the disclosure, the third processing module is further configured for:
sequentially setting wᵢ as a sub-model to be diagnosed according to the security sub-model sequence W;
obtaining a feedback data packet of the sub-model to be diagnosed at a current feedback time node;
generating an operation evaluation value g of the sub-model to be diagnosed at the current feedback time node according to the feedback data packet;

$$g = [ {\sum }_{i = 1}^{{θ}_{3}} {µ}_{i} * {k}_{i} ] ;$$

where, θ3 is a number of operation evaluation indexes; μᵢ is a reference value of an i-th operation evaluation index; kᵢ is a reference value of the i-th operation evaluation index generated based on the feedback data packet;
sequentially generating an operation evaluation value of each of the security sub-models at the current feedback time node;
building an operation evaluation value sequence G, and G=(g₁, g₂ . . . gᵢ . . . gₘ), where gᵢ is an operation evaluation value of the security sub-model at the current feedback time node;
presetting an operation evaluation value threshold G1; and
if gᵢ<G1, generating a first-level correction instruction of the i-th security sub-model at the current feedback time node.

In some embodiments of the disclosure, determining whether to generate a correction instruction according to all feedback data packets further includes:
generating a correction evaluation value h of the current feedback time node according to the operation evaluation value sequence G;

$$h = e 3 * Q 3 * [ {\sum }_{i = 1}^{m} {( {g}_{i} - g ′ )}^{2} ] + e 4 * Q 4 * [ {\sum }_{i = 1}^{m} Y ( i ) * ( {g}_{i} - G 1 ) ] ;$$

where e3 is a preset third weight coefficient; e4 is a preset fourth weight coefficient; Q3 is a preset third fixed coefficient; Q4 is a preset fourth fixed coefficient; g′is an average value of all operation evaluation values in the operation evaluation value sequence G; Y(i) is a selection coefficient; if (gᵢ−G1)>0, Y(i)=0; if (gᵢ−G1)<0, Y(i)=1/(gᵢ−G1);
presetting a correction evaluation value threshold H1; and
if h>H1, generating a second-level correction instruction at the current feedback time node.

Compared with the prior art, the cloud security resource pool system based on the distributed architecture in the embodiment of the disclosure has the following beneficial effects.

Based on the distributed architecture and virtualization technology, each security device is built as a virtual security machine, and a cloud resource pool is built according to all virtual security machines, so as to realize the dynamic call of all security resources, and at the same time, multiple request categories are built based on historical parameters, and corresponding security sub-models are constructed according to the characteristic parameters of different request categories, so as to realize the security monitoring efficiency of various data.

The resource proportion of each security sub-model is dynamically adjusted based on the expected request parameters of a single monitoring period, and at the same time, the resource call parameters of each security sub-model are dynamically corrected by building time sequences, thus improving the overall operating efficiency and security protection capability of the system.

### BRIEF DESCRIPTION OF THE DRAWINGS

FIG. 1 is a schematic structural diagram of a cloud security source pool system based on distributed architecture according to a preferred embodiment in the embodiment of the disclosure.

### DETAILED DESCRIPTION OF THE EMBODIMENTS

In the following, the specific embodiments of the disclosure will be further described in detail with the attached drawings and embodiments. The following embodiments are used to illustrate the disclosure, but are not used to limit the scope of the disclosure.

In the description of this disclosure, it should be understood that the azimuth or positional relationship indicated by the terms “center”, “up”, “down”, “front”, “back”, “left”, “right”, “vertical”, “horizontal”, “top”, “bottom”, “inside” and “outside” is based on the azimuth or positional relationship shown in the attached drawings, only for the convenience of describing this disclosure and simplifying the description, and may not indicate or imply that the referred device or element may have a specific orientation, be constructed and operated in a specific orientation, so it may not be understood as a limitation of this disclosure.

The terms “first” and “second” are only used for descriptive purposes, and may not be understood as indicating or implying relative importance or implicitly indicating the number of indicated technical features. Therefore, the features defined as “first” and “second” may include one or more of these features explicitly or implicitly. In the description of this disclosure, unless otherwise specified, “multiple” means two or more.

In the description of this disclosure, it should be noted that unless otherwise specified and limited, the terms “installation”, “connecting” and “connection” should be broadly understood, for example, fixed connection may be used, detachable connection or integrated connection may be used. It may be a mechanical connection or an electrical connection, may be directly connected, may also be indirectly connected through an intermediate medium, and may be connected inside two elements. For those skilled in the art, the specific meanings of the above terms in this disclosure may be understood in specific circumstances.

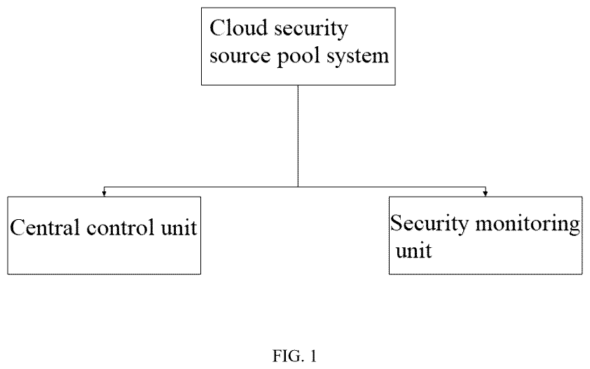

As shown in FIG. 1, a cloud security source pool system based on distributed architecture is provided and includes:
a central control unit, configured for building a cloud resource pool according to security device parameters, where the cloud resource pool includes multiple virtual security machines; and
a security monitoring unit, configured for setting multiple request categories according to network structure parameters;
where the security monitoring unit is further configured for constructing a security sub-model of each of the request categories;
where the central control unit includes:
a first processing module, configured for building a virtual security machine sequence A, and A=(a₁, a₂ . . . aᵢ . . . aₙ), where aᵢ is an i-th virtual security machine; n is a number of the virtual security machines;
a second processing module, configured for constructing the security sub-model of each of the request categories and setting resource call parameters of each of security sub-models; and
a third processing module, configured for obtaining a feedback data packet of each of security sub-models according to a preset feedback time node, and determining whether to generate a correction instruction according to all feedback data packets.

Specifically, each security device is virtualized to construct multiple virtual security machines, where a single virtual security machine represents a security device. Its security device includes but is not limited to firewall, intrusion monitoring model and anti-DDoS device, authentication gateway, etc. By virtualizing each security device, a cloud resource pool of security monitoring resources is constructed.

Specifically, the security monitoring unit includes:
a first monitoring module, configured for building a request category sequence P, and P=(p₁, p₂ . . . pᵢ . . . pₘ), where pᵢ is an i-th request category; m is a number of the request categories; and
a second monitoring module, configured for constructing the security sub-model of each of the request categories;
where the second monitoring module is further configured for obtaining real-time user request and setting scheduling parameters of the security sub-model according to the real-time user request.

Specifically, the second monitoring model may obtain the real-time user requests of each user terminal, generate the request categories corresponding to the real-time user requests through preprocessing, and call the corresponding security sub-model to perform security verification and security detection, so as to ensure the safe operation of the system and improve the security monitoring efficiency and protection capability of the system.

Specifically, multiple request categories are constructed based on historical parameters, and corresponding security sub-models are constructed according to the characteristic parameters of each request category, and the call parameters for each virtual security machine are set based on the requirements of the security sub-model, thus realizing the dynamic scheduling of all security resources in the system.

In the preferred embodiment of the embodiment of the disclosure, constructing the security sub-model of each of the request categories includes:
pᵢ is sequentially set as a target request category according to the request category sequence P;
a historical data packet of the target request category is generated;
an association evaluation value between the target request category and each of the virtual security machines is generated according to a request data packet;
an associated evaluation value sequence B of the target request category is built, and B=(b₁, b₂ . . . bᵢ . . . bₙ), where bᵢ is an associated evaluation value of the target request category and the i-th virtual security machine; n is a number of the virtual security machines;
an associated evaluation value threshold B1 is preset;
if bᵢ>B1, the i-th virtual security machine is set as an associated virtual machine of the target request category;
a call channel of the target request category and each of the associated virtual machines is generated, and a call substructure of the target request category is generated according to all call channels;
the security sub-model of the target request category is generated according to the call substructure;
the security sub-model of each of the request categories is sequentially generated;
a security sub-model sequence W is built, and W=(w₁, w₂ . . . . wᵢ . . . . wₘ), where wᵢ is a data sub-model of the i-th request category; m is a number of the request categories.

Specifically, according to the security monitoring resource parameters required in the target request category, the correlation evaluation value between the target request category and each virtual security machine is generated. When the correlation evaluation value is greater than the preset correlation evaluation value threshold, it means that the security monitoring resources required by the target request category exist in the current virtual security machine, and the current virtual security machine is set as the associated virtual machine of the target request category.

Specifically, the call channel between the target request category and each associated virtual machine is constructed based on the distributed architecture, so as to realize unified scheduling and elastic expansion of all security monitoring resources and meet different security requirements.

Specifically, generating the target request category and the associated evaluation value of each of the virtual security machines includes:
aᵢ is sequentially set as a target virtual security machine according to an virtual security machine sequence A;
an associated evaluation value b between the target virtual security machine and the target request category is generated according to the historical data packet;

$$b = [ {\sum }_{i = 1}^{{θ}_{1}} {η}_{i} * {s}_{i} ] ;$$

where, θ1 is a number of associated evaluation indexes; ηᵢ is an influence factor of an i-th associated evaluation index; sᵢ is a reference value of the i-th associated evaluation index generated based on the historical data packet.

Specifically, the greater the correlation evaluation value, the greater the demand of the target request category for the security resources corresponding to the current virtual security machine.

Specifically, the correlation evaluation index includes, but is not limited to, a number of parameters such as the historical call frequency and call times of the request data of the target request category to the security device corresponding to the target virtual security machine, and the fit between the security monitoring resources in the target virtual security machine and the demand parameters of the target request category. By quantifying each correlation evaluation index, the correlation relationship between the target request category and each security virtual machine is accurately evaluated.

Specifically, the corresponding influence factor is set according to the influence degree of the correlation evaluation index on the correlation degree between the target request category and the virtual security machine, and the greater the influence degree, the greater the corresponding influence factor.

It may be understood that in the above embodiment, based on the distributed architecture and virtualization technology, each security device is built as a virtual security machine, and a cloud resource pool is built according to all virtual security machines, so as to realize the dynamic call of all security resources, and at the same time, multiple request categories are built based on historical parameters, and corresponding security sub-models are constructed according to the characteristic parameters of different request categories, so as to realize the security monitoring efficiency of all kinds of data.

In the preferred embodiment of the embodiment of the disclosure, setting resource call parameters of each of security sub-models includes:
multiple monitoring periods are preset;
expected request parameters of a current monitoring period are generated according to a preset request prediction model;
an expected load value of each of the security sub-models in the current monitoring period is generated according to the expected request parameters;
a first-level resource call strategy is set according to all expected load values;
an expected fluctuation value of the current monitoring period is generated, and multiple time intervals in the current monitoring period are set according to the expected fluctuation value;
a time interval sequence T is built, and T=(t₁, t₂, . . . tᵢ, . . . tᵣ), where tᵢ is an i-th time interval; r is a number of the time intervals;
a deviation evaluation value in each of the time intervals is generated, and whether a compensation sub-strategy is generated in each of the time intervals is determined according to the deviation evaluation value.

Specifically, by analyzing the historical request parameters in the system, a request prediction model is constructed, and the request parameters in each monitoring period are predicted by combining the time characteristics.

Specifically, the duration of the monitoring period may be set according to historical parameters, and the request prediction model is constructed by analyzing the historical parameters, so as to predict the request parameters of each monitoring period, data support for subsequent security resource allocation is provide.

Specifically, the greater the expected fluctuation value, the shorter the duration of a single time interval, and the current monitoring period is divided according to the duration of the single time interval, thereby generating multiple time intervals.

Specifically, generating an expected load value of each of security sub-models in the current monitoring period includes:
wᵢ is sequentially set as a target sub-model according to the security sub-model sequence W;
an expected load value c of the target sub-model is generated according to the expected request parameters of the current monitoring period;

$$c = [ {\sum }_{i = 1}^{{θ}_{2}} {β}_{i} * {v}_{i} ] ;$$

where, θ2 is a number of load evaluation indexes; βᵢ is an influence factor of an i-th load evaluation index; vᵢ is a first-level reference value of the i-th load evaluation index in the target sub-model generated based on the expected request parameters;
an expected load value of each of the security sub-models in the current monitoring period is sequentially generated;
an expected load value sequence C of the current monitoring period is built, and C=(c₁, c₂ . . . . cᵢ . . . . cₘ), where cᵢ is an expected load value of an i-th security sub-model in the current monitoring period.

Specifically, the greater the expected load value, the more security resources the target sub-model needs.

Specifically, the load evaluation index includes, but is not limited to, the number of requests of the request category corresponding to the target sub-model, the amount of data to be monitored in the request, the request frequency, the peak value of the request amount and other parameters. By quantifying each load evaluation index, the accurate analysis of the operation load of the target sub-model is realized. The specific value rules of each load evaluation index may be set according to historical parameters.

Specifically, the greater the reference value of each load evaluation index, it means that the more security monitoring resources the current target sub-model needs to call, the greater the operation load corresponding to the target sub-model.

Specifically, the first-level reference value of the load evaluation index is based on the average value of the reference values of the load evaluation index in each unit time.

Specifically, when generating the first-level resource call strategy, the resource call amount for each associated virtual is set according to the expected load value of the target sub-model, and the mapping relationship between the expected load value and the resource call amount may be set according to historical parameters.

Specifically, after all the security sub-models are set with all the resource call parameters, it is checked in turn whether the resource call amount corresponding to each virtual security machine exceeds the resource threshold value of the virtual security machine, if so, the resource call parameters of the virtual security machine are corrected and allocated according to the proportion of the expected resource call amount of each associated security sub-model to the total expected resource call amount. If the threshold is not reached, no correction is needed.

In the preferred embodiment of the embodiment of the disclosure, setting multiple time intervals in the current monitoring period includes:
the expected fluctuation value d of the current monitoring period is generated;

$$d = e 1 * Q 1 * [ {\sum }_{i = 1}^{m} {j}_{i} ] + e 2 * Q 2 * [ {\sum }_{i = 1}^{m} {( {j}_{i} - j ′ )}^{2} ] ;$$

where e1 is a preset first weight coefficient; e2 is a preset second weight coefficient; Q1 is a preset first fixed coefficient; Q2 is a preset second fixed coefficient; jᵢ is a sub-fluctuation value of the i-th security sub-model in the current monitoring period; j′ is an evaluation value of all sub-fluctuation values;
a duration of a single time interval is set according to the expected fluctuation value d.

Specifically, the demand variation curve of each request category is generated according to the expected request parameters, the demand variation curve is divided according to the preset unit time, and the sub-load value of a single request category in each unit time is generated, and the sub-fluctuation value corresponding to the request category is set according to the variance of all sub-load values, and the larger the variance, the greater the corresponding sub-fluctuation value, and the expected fluctuation value is generated according to the sum of all sub-fluctuation values. Where, the unit time may be set according to historical parameters.

Specifically, all parameters in the model are normalized by presetting the first fixed coefficient and the second fixed coefficient, so that all parameters in the model are in the same range.

Specifically, determining whether a compensation sub-strategy is generated in each of the time intervals includes:
tᵢ is sequentially set as a target time interval according to the time interval sequence T;
a request sub-data packet of the target time interval is generated according to the expected request parameters of the current monitoring period;
wᵢ is sequentially set as a sub-model to be evaluated according to the security sub-model sequence W;
a load deviation value d of the sub-model to be evaluated in the target time interval is generated according to the request sub-data packet;

$$d = [ {\sum }_{i = 1}^{{θ}_{2}} {β}_{i} * {( {v}_{1 i} - {v}_{2 i} )}^{2} ] ;$$

where, θ2 is a number of the load evaluation indexes; βᵢ is an influence factor of the i-th load evaluation index; v₁ᵢ is a first-level reference value of an i-th load evaluation index in the sub-model to be evaluated generated based on the expected request parameters; v₂ᵢ is a second-level reference value of the sub-model to be evaluated generated based on the request sub-data packet in the target time interval;
a load deviation value of each of the security sub-models in the target time interval is sequentially generated;
a deviation evaluation value f of the target time interval is generated according to all load deviation values;

$$f = {\sum }_{i = 1}^{m} {d}_{i} ;$$

where, dᵢ is a load evaluation value of an i-th security sub-model in the target time interval;
a deviation evaluation value threshold F1 is preset;
if f>F1, the compensation sub-strategy of the target time interval is generated;
whether each of the time intervals generates the compensation sub-strategy is sequentially determined.

Specifically, the second-level reference value is the expected reference value of each load evaluation index within the target time interval.

Specifically, the greater the load deviation value, the greater the possibility of load fluctuation in the corresponding security sub-model in the current time interval.

Specifically, the deviation evaluation value threshold may be set according to historical parameters. If the deviation evaluation value in the target time interval is greater than the deviation evaluation value threshold, it means that the matching degree between the current first-level resource call strategy and the security monitoring requirements in the target time interval is worse, and the first-level resource call strategy is appropriately corrected according to the expected load value of each security sub-model in the target time interval, thus ensuring the security monitoring efficiency in the target time interval and improving the overall operating efficiency and security protection capability of the system.

It may be understood that in the above embodiment, the resource proportion of each security sub-model is dynamically adjusted based on the expected request parameters of a single monitoring period, and at the same time, the resource call parameters of each security sub-model are dynamically corrected by building time sequences, thus improving the overall operating efficiency and security protection capability of the system.

In a preferred embodiment of the embodiment of the disclosure, the third processing module is further configured for:
wᵢ is sequentially set as a sub-model to be diagnosed according to the security sub-model sequence W;
a feedback data packet of the sub-model to be diagnosed at a current feedback time node is obtained;
an operation evaluation value g of the sub-model to be diagnosed at the current feedback time node is generated according to the feedback data packet;

$$g = [ {\sum }_{i = 1}^{{θ}_{3}} {µ}_{i} * {k}_{i} ] ;$$

where, θ3 is a number of operation evaluation indexes; μᵢ is a reference value of an i-th operation evaluation index; kᵢ is a reference value of the i-th operation evaluation index generated based on the feedback data packet;
an operation evaluation value of each of the security sub-models at the current feedback time node is sequentially generated;
an operation evaluation value sequence G is built, and G=(g₁, g₂ . . . gᵢ . . . gₘ), where gᵢ is an operation evaluation value of the security sub-model at the current feedback time node;
an operation evaluation value threshold G1 is preset;
if gᵢ<G1, a first-level correction instruction of the i-th security sub-model is generated at the current feedback time node.

Specifically, the operation evaluation index includes but is not limited to the verification time, waiting time, false diagnosis rate and other parameters of a single request. The greater the reference value of the operation evaluation index, the higher the security monitoring efficiency of the current security sub-model is, and the stronger the protection ability is.

Specifically, the rules for selecting each operation evaluation index may be set according to historical parameters, and the corresponding influence factor may be set according to the correlation degree between each operation evaluation index and the security monitoring efficiency of the security sub-model. The greater the correlation degree, the greater the corresponding influence factor.

Specifically, the first-level correction instruction refers to correcting the call substructure and resource call parameters of the sub-model to be evaluated, so as to improve the operation efficiency of the sub-model to be evaluated.

Specifically, determining whether to generate a correction instruction according to all feedback data packets further includes:
a correction evaluation value h of the current feedback time node is generated according to the operation evaluation value sequence G;

$$h = e 3 * Q 3 * [ {\sum }_{i = 1}^{m} {( {g}_{i} - g ′ )}^{2} ] + e 4 * Q 4 * [ {\sum }_{i = 1}^{m} Y ( i ) * ( {g}_{i} - G 1 ) ] ;$$

where e3 is a preset third weight coefficient; e4 is a preset fourth weight coefficient; Q3 is a preset third fixed coefficient; Q4 is a preset fourth fixed coefficient; g′ is an average value of all operation evaluation values in the operation evaluation value sequence G; Y(i) is a selection coefficient; if (gᵢ−G1)>0, Y(i)=0; if (gᵢ−G1)<0, Y(i)=1/(gᵢ−G1);
a correction evaluation value threshold H1 is preset;
if h>H1, a second-level correction instruction is generated at the current feedback time node;

Specifically, the corrected evaluation value threshold may be set according to historical parameters. When the second-level correction instruction is generated, it means that the prediction accuracy of the current request prediction model is poor, and optimization iteration is needed in time to improve prediction accuracy and provide data support for subsequent resource call allocation.

Specifically, each parameter in the model is normalized by presetting the third fixed coefficient and the fourth fixed coefficient, so that each parameter in the model is within the same value range.

According to the first concept of the disclosure, based on the distributed architecture and virtualization technology, each security device is built as a virtual security machine, and a cloud resource pool is built according to all virtual security machines, so as to realize the dynamic call of all security resources, and at the same time, multiple request categories are built based on historical parameters, and corresponding security sub-models are constructed according to the characteristic parameters of different request categories, so as to realize the security monitoring efficiency of various data.

According to the second concept of the disclosure, the resource proportion of each security sub-model is dynamically adjusted based on the expected request parameters of a single monitoring period, and at the same time, the resource call parameters of each security sub-model are dynamically corrected by building time sequences, thus improving the overall operating efficiency and security protection capability of the system.

What has been described above is only the preferred embodiment of the disclosure, and it should be pointed out that some improvements and substitutions may be made by ordinary skilled in this field without departing from the technical principles of this disclosure, and these improvements and substitutions should also be regarded as the protection scope of this disclosure.

What is claimed is:

1. A cloud security source pool system based on distributed architecture, comprising:
a central control unit, configured for building a cloud resource pool according to security device parameters, wherein the cloud resource pool comprises a plurality of virtual security machines; and
a security monitoring unit, configured for setting a plurality of request categories according to network structure parameters;
wherein the security monitoring unit is further configured for constructing a security sub-model of each of the request categories;
wherein the central control unit comprises:
a first processing module, configured for building a virtual security machine sequence A, and A=(a₁, a₂ . . . aᵢ . . . aₙ), wherein aᵢ is an i-th virtual security machine; n is a number of the virtual security machines;
a second processing module, configured for constructing the security sub-model of each of the request categories and setting resource call parameters of each of security sub-models; and
a third processing module, configured for obtaining a feedback data packet of each of security sub-models according to a preset feedback time node, and determining whether to generate a correction instruction according to all feedback data packets.

2. The cloud security source pool system based on distributed architecture according to claim 1, wherein the security monitoring unit comprises:
a first monitoring module, configured for building a request category sequence P, and P= (p₁, p₂ . . . pᵢ . . . . Pₘ), wherein pᵢ is an i-th request category; m is a number of the request categories; and
a second monitoring module, configured for constructing the security sub-model of each of the request categories;
wherein the second monitoring module is further configured for obtaining real-time user request and setting scheduling parameters of the security sub-model according to the real-time user request.

3. The cloud security source pool system based on distributed architecture according to claim 2, wherein constructing the security sub-model of each of the request categories comprises:
sequentially setting pᵢ as a target request category according to the request category sequence P;
generating a historical data packet of the target request category;
generating an association evaluation value between the target request category and each of the virtual security machines according to a request data packet;
building an associated evaluation value sequence B of the target request category, and B=(b₁, b₂ . . . bᵢ . . . bₙ), wherein bᵢ is an associated evaluation value of the target request category and the i-th virtual security machine; n is a number of the virtual security machines;
presetting an associated evaluation value threshold B1;
if bᵢ>B1, setting the i-th virtual security machine as an associated virtual machine of the target request category;
generating a call channel of the target request category and each of the associated virtual machines, and generating a call substructure of the target request category according to all call channels;
generating the security sub-model of the target request category according to the call substructure;
sequentially generating the security sub-model of each of the request categories; and
building a security sub-model sequence W, and W=(w₁, W₂ . . . . wᵢ . . . . wₘ), wherein wᵢ is a data sub-model of the i-th request category; m is a number of the request categories.

4. The cloud security source pool system based on distributed architecture according to claim 3, wherein generating the target request category and the associated evaluation value of each of the virtual security machines comprises:
sequentially setting aᵢ as a target virtual security machine according to an virtual security machine sequence A; and
generating an associated evaluation value b between the target virtual security machine and the target request category according to the historical data packet;
$$b = [ {\sum }_{i = 1}^{{θ}_{1}} {η}_{i} * {s}_{i} ] ;$$
wherein, θ1 is a number of associated evaluation indexes; ηᵢ is an influence factor of an i-th associated evaluation index; sᵢ is a reference value of the i-th associated evaluation index generated based on the historical data packet.

5. The cloud security source pool system based on distributed architecture according to claim 3, wherein setting resource call parameters of each of security sub-models comprises:
presetting a plurality of monitoring periods;
generating expected request parameters of a current monitoring period according to a preset request prediction model;
generating an expected load value of each of the security sub-models in the current monitoring period according to the expected request parameters;
setting a first-level resource call strategy according to all expected load values;
generating an expected fluctuation value of the current monitoring period, and setting a plurality of time intervals in the current monitoring period according to the expected fluctuation value;
building a time interval sequence T, and T=(t₁, t₂, . . . tᵢ, . . . tᵣ), wherein tᵢ is an i-th time interval; r is a number of the time intervals; and
generating a deviation evaluation value in each of the time intervals, and determining whether a compensation sub-strategy is generated in each of the time intervals according to the deviation evaluation value.

6. The cloud security source pool system based on distributed architecture according to claim 5, wherein generating an expected load value of each of security sub-models in the current monitoring period comprises:
sequentially setting wᵢ as a target sub-model according to the security sub-model sequence W;
generating an expected load value c of the target sub-model according to the expected request parameters of the current monitoring period;
$$c = [ {\sum }_{i = 1}^{{θ}_{2}} {β}_{i} * {v}_{i} ] ;$$
wherein, θ2 is a number of load evaluation indexes; βᵢ is an influence factor of an i-th load evaluation index; vᵢ is a first-level reference value of the i-th load evaluation index in the target sub-model generated based on the expected request parameters;
sequentially generating an expected load value of each of the security sub-models in the current monitoring period; and
building an expected load value sequence C of the current monitoring period, and C=(c₁, c₂ . . . cᵢ . . . . cₘ), wherein cᵢ is an expected load value of an i-th security sub-model in the current monitoring period.

7. The cloud security source pool system based on distributed architecture according to claim 6, wherein setting a plurality of time intervals in the current monitoring period comprises:
generating the expected fluctuation value d of the current monitoring period;
$$d = e 1 * Q 1 * [ {\sum }_{i = 1}^{m} {j}_{i} ] + e 2 * Q 2 * [ {\sum }_{i = 1}^{m} {( {j}_{i} - j ′ )}^{2} ] ;$$
wherein e1 is a preset first weight coefficient; e2 is a preset second weight coefficient; Q1 is a preset first fixed coefficient; Q2 is a preset second fixed coefficient; jᵢ is a sub-fluctuation value of the i-th security sub-model in the current monitoring period; j′ is an evaluation value of all sub-fluctuation values; and
setting a duration of a single time interval according to the expected fluctuation value d.

8. The cloud security source pool system based on distributed architecture according to claim 6, wherein determining whether a compensation sub-strategy is generated in each of the time intervals comprises:
sequentially setting tᵢ as a target time interval according to the time interval sequence T;
generating a request sub-data packet of the target time interval according to the expected request parameters of the current monitoring period;
sequentially setting wᵢ as a sub-model to be evaluated according to the security sub-model sequence W;
generating a load deviation value d of the sub-model to be evaluated in the target time interval according to the request sub-data packet;
$$d = [ {\sum }_{i = 1}^{{θ}_{2}} {β}_{i} * {( {v}_{1 i} - {v}_{2 i} )}^{2} ] ;$$
wherein, θ2 is a number of the load evaluation indexes; ηᵢ is an influence factor of the i-th load evaluation index; v₁ᵢ is a first-level reference value of an i-th load evaluation index in the sub-model to be evaluated generated based on the expected request parameters; v₂ᵢ is a second-level reference value of the sub-model to be evaluated generated based on the request sub-data packet in the target time interval;
sequentially generating a load deviation value of each of the security sub-models in the target time interval;
generating a deviation evaluation value f of the target time interval according to all load deviation values;
$$f = {\sum }_{i = 1}^{m} {d}_{i} ;$$
wherein, dᵢ is a load evaluation value of an i-th security sub-model in the target time interval;
presetting a deviation evaluation value threshold F1;
if f>F1, generating the compensation sub-strategy of the target time interval; and
sequentially determining whether each of the time intervals generates the compensation sub-strategy.

9. The cloud security source pool system based on distributed architecture according to claim 8, wherein the third processing module is further configured for:
sequentially setting wᵢ as a sub-model to be diagnosed according to the security sub-model sequence W;
obtaining a feedback data packet of the sub-model to be diagnosed at a current feedback time node;
generating an operation evaluation value g of the sub-model to be diagnosed at the current feedback time node according to the feedback data packet;
$$g = [ {\sum }_{i = 1}^{{θ}_{3}} {µ}_{i} * {k}_{i} ] ;$$
wherein, θ3 is a number of operation evaluation indexes; μᵢ is a reference value of an i-th operation evaluation index; kᵢ is a reference value of the i-th operation evaluation index generated based on the feedback data packet;
sequentially generating an operation evaluation value of each of the security sub-models at the current feedback time node;
building an operation evaluation value sequence G, and G=(g₁, g₂ . . . gᵢ . . . gₘ), wherein gᵢ is an operation evaluation value of the security sub-model at the current feedback time node;
presetting an operation evaluation value threshold G1; and
if gᵢ<G1, generating a first-level correction instruction of the i-th security sub-model at the current feedback time node.

10. The cloud security source pool system based on distributed architecture according to claim 9, wherein determining whether to generate a correction instruction according to all feedback data packets further comprises:
generating a correction evaluation value h of the current feedback time node according to the operation evaluation value sequence G;
$$h = e 3 * Q 3 * [ {\sum }_{i = 1}^{m} {( {g}_{i} - g ′ )}^{2} ] + e 4 * Q 4 * [ {\sum }_{i = 1}^{m} Y ( i ) * ( {g}_{i} - G 1 ) ] ;$$
wherein e3 is a preset third weight coefficient; e4 is a preset fourth weight coefficient; Q3 is a preset third fixed coefficient; Q4 is a preset fourth fixed coefficient; g′ is an average value of all operation evaluation values in the operation evaluation value sequence G; Y(i) is a selection coefficient; if (gᵢ−G1)>0, Y(i)=0; if (gᵢ−G1)<0, Y(i)=1/(gᵢ−G1);
presetting a correction evaluation value threshold H1; and
if h>H1, generating a second-level correction instruction at the current feedback time node.
